(19) United States
(12) Patent Application Publication
(10) Pub. No.: US 2008/0290064 A1
(43) Pub. Date: Nov. 27, 2008

(54) METHOD FOR FORMING SAPPHIRE MICRO-LENS IN LED PROCESS

(76) Inventor: Ki-Jun Yun, Suwon-si (KR)

Correspondence Address: SHERR & VAUGHN, PLLC, 620 HERNDON PARKWAY, SUITE 200, HERNDON, VA, 20170, US

(21) Appl. No.: 12/125,952

(22) Filed: May 23, 2008

(30) Foreign Application Priority Data
May 25, 2007 (KR) 10-2007-0050895

(51) Int. Cl. B29D 11/00; C23F 1/00

(52) U.S. Cl. 216/26; 156/345.33

(57) ABSTRACT

A method for forming a micro-lens on a sapphire substrate in an LED process. In the method for forming the micro-lens on the sapphire substrate in the LED process, the ratio of source power and bias power used to generate plasma into a chamber is set to the optimum ratio of 3:1 in order to minimize the burning phenomenon of a photoresist mask caused by plasma having strong potential when a conventional micro-lens is formed. In essence, plasma having low potential energy can be realized in RIE etch used to form the micro-lens on the sapphire substrate, thereby minimizing the burning phenomenon of the photoresist mask. A yield rate can be improved in the LED process.

The present application claims priority under 35 U.S.C. 119 and 35 U.S.C. 365 to Korean Patent Application No. 10-2007-0050895 (filed on May 25, 2007), which is hereby incorporated by reference in its entirety.

### BACKGROUND

An LED is an important solid element for converting electrical energy into light. The LED may include an active layer, which includes a semiconductor material and interposed between two opposite doping layers. If a bias is applied to both ends of the two doping layers, electrons are mated with holes in the active layer to emit light after the holes and the electrons are injected into the active layer.

In order to realize the above LED, a material such as sapphire may be used. Since sapphire has a rigid crystal structure, a reaction ion etching (RIE) scheme may be used when a sapphire substrate is etched in order to form a micro-lens. However, when using RIE to form a micro-lens on a sapphire substrate, a photoresist burning phenomenon may occur. In this occurrence, a photoresist mask used to form the micro-lens on the sapphire substrate is burned due to strong plasma when the power source and bias power are excessively supplied in order to generate the plasma in a chamber. In addition, if power for the RIE is lowered in order to solve the above problem, etching selectivity between photoresist and sapphire may not be formed to a desired level, so that etching time may be prolonged. In addition, a cooling step must be added whenever the etching process is performed, so that throughput may be lowered.

### SUMMARY

Embodiments relate to a method for forming a sapphire micro-lens in an LED process, which minimizes burning of a photoresist mask resulting from plasma having strong potential when a micro-lens is formed on and/or over a sapphire substrate in an LED process

Embodiments relate to a method for forming a sapphire micro-lens in an LED process that can include at least one of the following steps: (a) coating a photoresist layer in order to form an LED on and/or over a sapphire substrate for the LED; and then (b) forming a mask pattern used to form a micro-lens on and/or over the sapphire substrate by performing a photolithography process with respect to the photoresist layer; and then (c) forming a plurality of micro-lenses having a semi-circular shape, on and/or over the sapphire substrate by performing reaction ion etching with respect to the sapphire substrate formed thereon and/or thereover with the photoresist mask in a chamber.

Embodiments relate to an apparatus that can include at least one of the following: a chamber; an antenna provided at an upper portion of the chamber; an electrode provided at a lower portion of the chamber; a source power unit for supplying first power to the antenna; and a bias power unit for supplying second power to the electrode.

### DRAWINGS

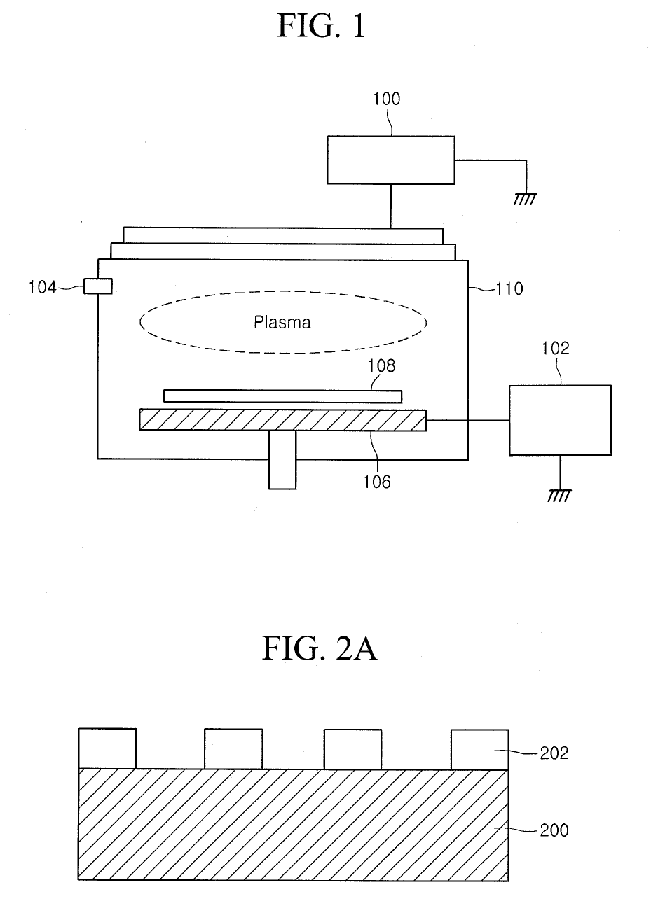

Example FIG. 1 illustrates an RIE etch chamber system, in accordance with embodiments.

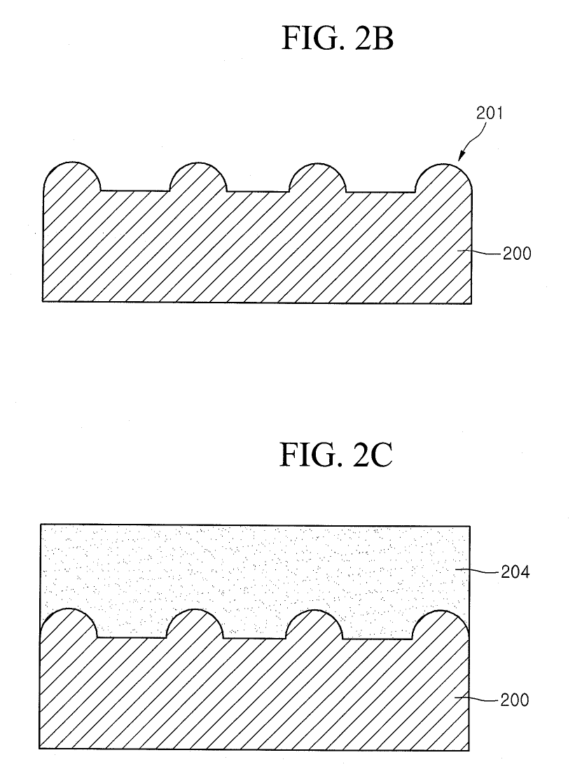

Example FIGS. 2A to 2C illustrate a process of forming a micro-lens on a sapphire substrate through RIE etching, in accordance with embodiments.

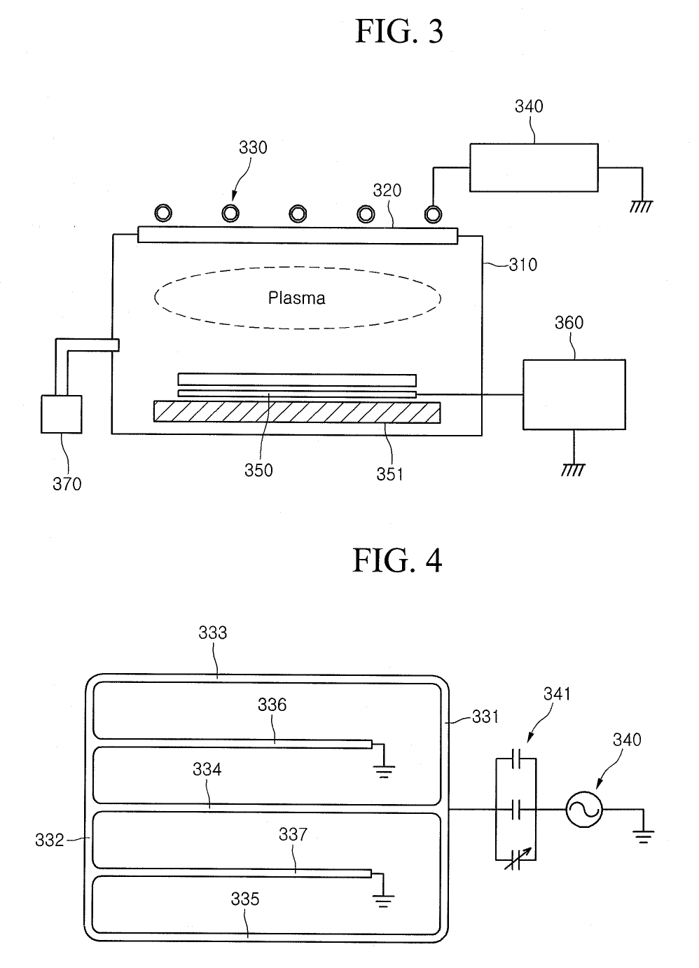

Example FIG. 3 illustrates the structure of an RIE etch chamber to form a sapphire micro-lens, in accordance to embodiments.

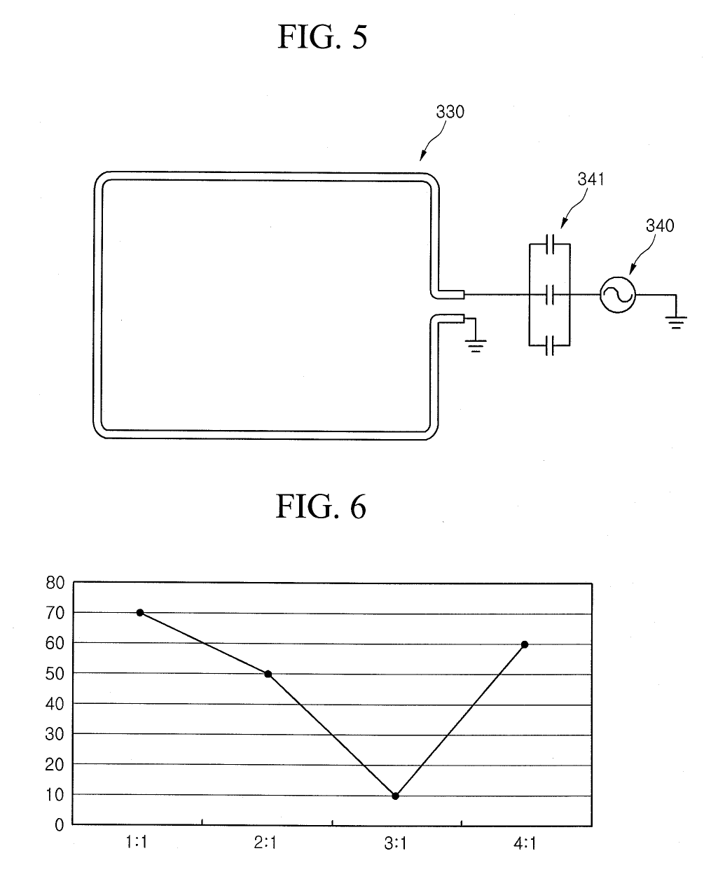

Example FIGS. 4 and 5 illustrates antennas, in accordance with embodiments

Example FIG. 6 illustrates a graph showing a photoresist burning rate according to the ratio of source and bias power, in accordance with embodiments.

### DESCRIPTION

As illustrated in example FIG. 1, RIE etch chamber 110 can include gas inlet 104 in communication with etch chamber 110 and through which a reaction gas is introduced. RIE etch chamber 110 can be a vacuum chamber. Substrate support 106 for supporting a substrate that will undergo RIE etch process. First power unit 100 (source power) and second power unit 102 (bias power) can be connected to etch chamber 110 for generating plasma for an RIE etch process.

Regarding the operation of the RIE etch chamber system, reaction gas can be injected through gas inlet 104 provided in the RIE etch chamber 110 and bias power can be supplied to a cathode of substrate support 106, and source power can be supplied to an anode of substrate support 106, thereby generating plasma vertically above sapphire substrate 108 in vacuum chamber 110. At this time, ions of the plasma can be vertically incident onto sapphire substrate 108 placed on the cathode such that RIE etch is performed with respect to sapphire substrate 108 through ion impact, except for the area where a photoresist mask is formed.

In order to form a micro-lens, during performance of an etch process with respect to sapphire substrate 108 having the photoresist mask deposited thereon in vacuum chamber 110, the photoresist mask can be burned due to plasma having strong potential, so that the etch process for the micro-lens may not be not achieved with accuracy. Therefore, in accordance with embodiments, in order to prevent the photoresist mask from being burned due to the plasma formed above sapphire substrate 108 source power unit 100 can be connected to the anode in chamber 110 to apply RF power of 300 W to 1800 W and bias power unit 102 can be connected to the cathode of substrate support 106 to apply LF power of 380 KHz having a level of 100 W to 600 W. Accordingly, source power unit 100 and bias power unit 102 can be controlled to apply power in the ratio of 2.5 to 3.5:1; which is experimentally obtained in order to minimize a photoresist burning phenomenon. In other words, low plasma density can be realized above sapphire substrate 108 in chamber 110, thereby preventing a photoresist mask from being burned. It is preferred that temperature of the substrate support 106 is maintained in range of about 15° C. to −25° C. In more detail, it is preferred that the temperature of the substrate support 106 is maintained to −20° C. or less to minimize the damage of the photoresist mask caused by plasma.

Example FIGS. 2A to 2C illustrate sectional views of the process of forming a micro-lens on a sapphire substrate in a chamber having process conditions established in accordance with embodiments.

As illustrated in example FIG. 2A, after coating a photoresist layer on and/or over sapphire substrate (Al₂O₃) 200 in order to form a micro-lens thereon and/or thereover, predetermined photoresist mask 202 can be formed through a photolithography process.

As illustrated in example FIG. 2B, after moving sapphire substrate 200 including photoresist mask 202 into chamber 110, micro-lens 201 can be formed on and/or over sapphire substrate 200 using RIE etching. When the RIE etch is performed, source power of 900 W and bias power of 300 W can be used in order to prevent burning of photoresist mask 202 due to plasma having strong potential. In this way, the source power and the bias power can have a ratio of 3:1.

As illustrated in example FIG. 2C, after forming a GaN layer 204 on and/or over micro-lens 201 of sapphire substrate 200, an electrode layer for an light emitting diode (LED) can then be formed, thereby forming an LED.

As described above, in the method for forming a micro-lens on a sapphire substrate in an LED process in accordance with embodiments, the ratio of source power and bias power used to generate plasma into a processing chamber can be set to an optimum ratio of 3:1. Such a ration can minimize the burning phenomenon of a photoresist mask caused by plasma having strong potential. Accordingly, plasma having low potential energy can be realized in RIE etch used to form a micro-lens on a sapphire substrate, thereby minimizing the burning phenomenon of the photoresist mask. Therefore, a yield rate can be improved in the LED process.

As illustrated in example FIG. 3, an RIE etch device in accordance with embodiments can include chamber 310 and ceramic window 320 provided on and/or over a wall of chamber. A plurality of antennas 330 can be placed on and/or over ceramic window 320. First power source such as source power unit 340 can be in communication with antenna 330. Substrate support 351 may be provided in chamber 310 facing below, above or on the side of ceramic window 320. Electrode 350 can be placed on and/or over substrate support 351 and in communication with second power source such as bias power unit 36. Gas supply unit 370 can be in communication with chamber 310 to supply gas for forming plasma in chamber during etching.

Ceramic window 320 can be provided at an upper portion of chamber 310 to prevent the antenna 330 from being damaged due to plasma generated inside chamber 310. Antenna 330 can be provided above ceramic window 320 and spaced apart therefrom by a distance of about 0.5 cm to about 1 cm.

As illustrated in example FIG. 4, antenna 330 can includes a plurality of pipes connected to each other. The pipe can be formed of copper, and can serve as a conductor. Antenna 330 can include first connection pipe 331 and second connection pipe 332 provided in opposition to each other. First pipe 333, second pipe 334 and third pipe 335 are in provided in parallel to each other and in communication with first connection pipe 331 and second connection pipe 332, extending perpendicular thereto. Particularly, first pipe 333, second pipe 334 and second pipe 335 can serve to connect first connection pipe 331 to second connection pipe 332. Fourth pipe 336 can be interposed between first pipe 333 and second pipe 334, and connected to second connection pipe 332. Fifth pipe 337 can be interposed between second pipe 334 and third pipe 335, and connected to second connection pipe 332. Accordingly, first connection pipe 331 and second connection pipe 332 can be integrally formed with first pipe 333, second pipe 334, third pipe 335, fourth pipe 336 and fifth pipe 337. As illustrated in example FIG. 5, antenna 330 can alternatively be bent to have a ring shape.

In operation, source power unit 340 can supply RF power to antenna 330. A plurality of capacitors 341 can be connected in parallel with each other between source power unit 340 and antenna 330. Source power unit 340 can supply RF power in a range of about 300 W to about 1800 W to antenna 330. Support 351 is provided to support electrode 350 and sapphire substrate provided on and/or over electrode 350. Electrode 350 can receive LF power from bias power unit 360. Bias power unit 360 can supply LF power in a range of about 100 W to about 600 W to electrode 350. When the RF power and the LF power have a ratio of 2.5 to 3.5:1, it is possible to prevent the burning of a photoresist mask formed on the sapphire substrate. The RF power and the LF power can have a ratio of 3:1.

Gas supply unit 370 can supply one or more gases, such as Ar, BCl₃, and Cl₂, to chamber 310. In order to form a sapphire micro-lens, the sapphire substrate formed with a photoresist mask can be provided inside chamber 310, and on and/or over electrode 350. Gas supply unit 370 can then supply Ar in the range of 300 sccm to 500 sccm to the inside of chamber 310. Gas supply unit 370 can simultaneously supply BCl₃ in the range of 40 sccm to 70 sccm and Cl₂ in the range of 20 sccm to 35 sccm to the inside of chamber 310. The supply ratio of BCl₃ and Cl₂ can be in range of 1.75:1 to 2.25:1. In more detail, the supply ratio can be 2:1. Source power unit 340 can then supply RF power in the range of 300 W to 1800 W to antenna 330 and bias power unit 360 can supply LF power in the range of 100 W to 600 W to electrode 350. The RF power and the LF power can be supplied to antenna 330 and electrode 350, respectively, in a ratio of 2.5:1 to 3.5:1. The RF power and the LF power can alternatively be supplied to antenna 330 and electrode 350, respectively, in a ratio of 3:1. Subsequently, after generating plasma inside chamber 310, the sapphire substrate is etched, so that a micro-lens is formed on and/or over the sapphire substrate. As a result, burning of the photoresist mask is altogether reduced.

As illustrated in example FIG. 6, a graph shows a burning rate of the photoresist mask formed on and/or over a sapphire substrate in relation to the ratio of the source power and the bias power. It can be recognized that during an RIE etch process performed in a chamber in accordance with embodiments, the burning rate of the photoresist mask has its lowest value at a point where the ratio of the source power and the bias power becomes 3:1.

Any reference in this specification to “one embodiment,” “an embodiment,” “example embodiment,” etc., means that a particular feature, structure, or characteristic described in connection with the embodiment is included in at least one embodiment of the invention. The appearances of such phrases in various places in the specification are not necessarily all referring to the same embodiment. Further, when a particular feature, structure, or characteristic is described in connection with any embodiment, it is submitted that it is within the purview of one skilled in the art to effect such feature, structure, or characteristic in connection with other ones of the embodiments.

Although embodiments have been described with reference to a number of illustrative embodiments thereof, it should be understood that numerous other modifications and embodiments can be devised by those skilled in the art that will fall within the spirit and scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. A method for forming a sapphire micro-lens for an LED, the method comprising:
providing a sapphire substrate on a support; and then
coating a photoresist layer on a sapphire substrate in order to form an LED; and then
forming a mask pattern on the sapphire substrate; and then
forming a plurality of micro-lenses on the sapphire substrate by performing reaction ion etching with respect to the sapphire substrate.

2. The method of claim 1, wherein during forming the plurality of microlenses, the reaction ion etching is performed using a plasma source in a state in which a ratio between a source power and a bias power is set to a ratio of 2.5:1 to 3.5:1.

3. The method of claim 2, wherein during forming the plurality of micro-lenses, the substrate support is maintained at a temperature in range of −15° C. to −25° C.

4. The method of claim 2, wherein during forming the plurality of micro-lenses, the source power is set in a range of 300 W to 1800 W.

5. The method of claim 2, wherein during forming the plurality of micro-lenses, the bias power is set in a range of 100 W to 600 W.

6. The method of claim 1, wherein forming the mask pattern comprises performing a photolithography process with respect to the photoresist layer.

7. A reaction ion etching apparatus comprising:
a chamber for receiving a substrate;
an antenna provided over an upper portion of the chamber;
an electrode provided in a lower portion of the chamber;
a source power unit for supplying a first power to the antenna; and
a bias power unit for supplying a second power to the electrode.

8. The reaction ion etching apparatus of claim 7, wherein the antenna comprises at least one conductive pipe.

9. The reaction ion etching apparatus of claim 7, wherein the antenna comprises at a plurality of conductive pipes connected to each other in parallel.

10. The reaction ion etching apparatus of claim 8, further comprising a ceramic window provided in a surface wall of the chamber, wherein the antenna is provided over the ceramic window.

11. The reaction ion etching apparatus of claim 7, wherein the first power and the second power have a ratio of 2.5:1 to 3.5:1.

12. The reaction ion etching apparatus of claim 7, wherein the first power is in a range of about 300 W to about 1800 W band the second power is in a range of about 100 W to about 600 W.

13. The reaction ion etching apparatus of claim 7, further comprising a gas supply unit for supplying a gas for generating plasma in the chamber.

14. The reaction ion etching apparatus of claim 13, wherein the gas supply unit supplies Ar in a range of 300 sccm to 500 sccm, BCl₃ in a range of 40 sccm to 70 sccm, and Cl₂ in a range of 20 sccm to 35 sccm.

15. The reaction ion etching apparatus of claim 7, wherein the chamber has an internal pressure in a range of 1 mtorr to 3 mtorr.

16. A method for forming a micro-lens comprising:
providing a sapphire substrate on a support in a chamber; and then
coating a photoresist layer on a sapphire substrate; and then
forming a mask pattern on the sapphire substrate; and then
performing a reaction ion etching process on the sapphire substrate while maintaining the support at a temperature in range of −15° C. to −25° C. to form a micro-lens composed of sapphire.

17. The method of claim 16, wherein performing the reaction ion etching process comprises supplying a source power to the chamber and a bias power to the support at a ratio of 2.5:1 to 3.5:1.

18. The method of claim 16, wherein performing the reaction ion etching process comprises supplying a source power to the chamber in a range of about 300 W to about 1800 W and a bias power to the support in a range of about 100 W to about 600 W.

19. The method of claim 16, wherein performing the reaction ion etching process comprises supplying Ar in a range of 300 sccm to 500 sccm, BCl₃ in a range of 40 sccm to 70 sccm, and Cl₂ in a range of 20 sccm to 35 sccm.

20. The method of claim 19, wherein the supply ratio of BCl₃ and Cl₂ is 1.75:1 to 2.25:1.
